(19) United States
(12) Patent Application Publication
(10) Pub. No.: US 2007/0209504 A1
(43) Pub. Date: Sep. 13, 2007

(54) Method, Arrangement And Use Of Arrangement For Separating Elements And/Or Their Compounds From Each Other

(76) Inventors: Erik Backlund, SKELLEFTEA (SE); Nils-Olov Lindfors, Gammelstad (SE)

Correspondence Address: Mark P Stone, 25 Third Street 4th Floor, Stamford, CT, 06905, US

(21) Appl. No.: 11/579,260

(22) PCT Filed: May 2, 2005
(86) PCT No.: PCT/SE05/00638

§ 371 Date: Nov. 1, 2006

(30) Foreign Application Priority Data
May 4, 2004 (SE) SE 0401164-9

(51) Int. Cl. B03C 1/00

(52) U.S. Cl. 95/28; 96/1

(57) ABSTRACT

The present invention relates to a method to separate different materials from each other, such as, for example, elements and/or compounds of elements. The material (A-D) is pre-treated in a cyclone device (10) that comprises a restricted outlet (21) for a gaseous medium and an outlet (14) for material treated in the cyclone device, whereby the cyclone device (10) breaks the material (A-D) down into smaller fractions and changes the magnetic properties of the materials, and in that the different materials

[symbol]

The present invention relates to a method for separating different elements and/or their compounds from each other.

### BACKGROUND TO THE INVENTION

Ceramic linings are used in the metallurgical industry in ovens, ladles, converters and other vessels. Ceramics based on, for example, magnesium oxide, aluminium oxide or zirconium oxide may be used. The surface layer is subject to wear and is infiltrated in its cracks and pores by the molten metal and/or the slag. When the bricks are removed, they are normally deposited in storage due to the contamination they have acquired. Magnesium oxide has a value of SEK 4-10/kg and zirconium oxide has a value of SEK 50-100/k, and thus a method for recovering a part of the oxide would be of major economic value. Titanium white is an oxide of titanium that is used as a pigment. The new deposits of ilmenite that are currently being surveyed consist to a major part of eluvial sand that is contaminated with chrome oxide, which must be removed in order to obtain pigment. The removal of chrome oxide is an expensive process, and a simpler and cheaper method would be of major economic value. There are innumerable other areas in which a simple and cheap method for separating different minerals is required. It is known through U.S. Pat. No. 6,517,015 B2 that it is possible to increase the paramagnetic susceptibility of; for example, granite in a cyclone.

### OBJECT OF THE INVENTION

It is an aim of the invention to accomplish a method for separating different elements or their compounds from each other. The elements or their compounds are, according to the invention, pretreated in a cyclone that includes a vortex collector with an outlet that is restricted, and the different elements or their compounds are subsequently separated from each other by means of magnetic separation.

### BRIEF DESCRIPTION OF THE DRAWINGS

FIG. 1 is a longitudinal section through a cyclone that can be used for carrying out the method according to the invention.

FIG. 2 is an enlargement of a detail shown in FIG. 1.

FIG. 3 is a schematic illustration of the invention.

### DETAILED DESCRIPTION OF THE DEVICE DISPLAYED AND OF METHODS AS EXAMPLES OF THE INVENTION

FIG. 1 shows a cyclone that can be used for the method according to the invention. It has a body with a cylindrical part 11 with a tangential inlet from an inlet line 12. The cylindrical part is contiguous with a conical part 13 with a bottom outlet 14. A vortex collector in the form of a cylindrical pipe 15 that may have a conical end 16 extends downwards through the cover 17 of the cylindrical part and acts as an air outlet to the atmosphere. The axial position of the vortex collector can be adjusted as has been indicated in the drawing by the lifting jacks 18,19. A restriction for the outlet is formed by a cone 20 such that a ring-shaped exit slit 21 is formed, and such that this slit can be adjusted by changing the axial position of the cone 20 relative to the pipe 15 with the screw 22.

When air or another gas is blown into the inlet line 12 by a fan, not shown in the drawing, a downwardly moving vortex is formed that subsequently turns and forms a central upwardly moving vortex that is collected by the vortex collector 15. The dashed-dotted lines 30 show the boundary between excess pressure on its outer surface and negative pressure on its inner surface.

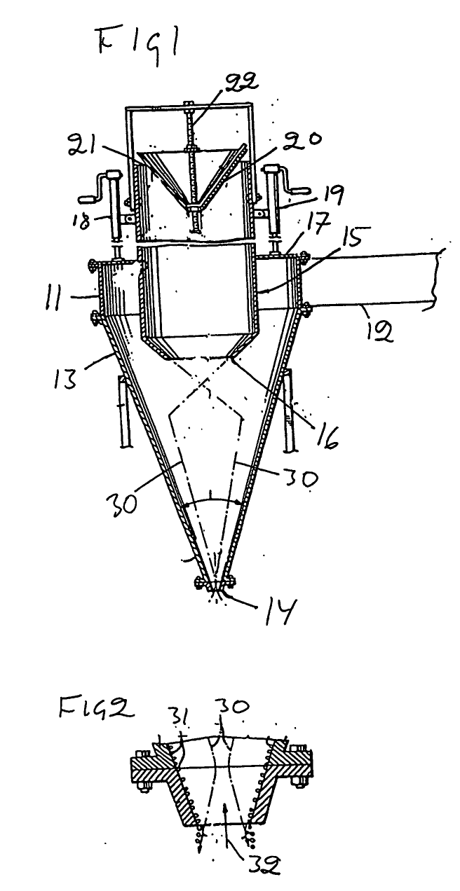

The bottom outlet 14 is shown in more detail as FIG. 2, and it is there made clear that the material 31 that is added to the inlet air in the inlet line 12 is deposited onto the conical wall and is transported downwards and out of the outlet. The drawing of the dashed-dotted lines 30, which are also present in FIG. 1, makes it clear that there is excess pressure along the wall while there is negative pressure in the centre of the outlet, such that air flows inwards, as is shown by the arrow 32, which is why it is an alternative that material can be introduced there instead of in the inlet air line 12. The outlet 14 can be modified such that it becomes ring-shaped. The cyclone and its properties are not described in more detail here, since a cyclone of this type is described in more detail in U.S. Pat. No. 5,236,132; U.S. Pat. No. 5,598,979; and U.S. Pat. No. 6,517,015 B2. Reference is made to these documents.

### Example 1

Magnesite bricks removed from a steel oven (an LD converter) were crushed to give a particle size of approximately maximum 35 mm and magnetically separated such that the major part of the metallic iron and a portion of the iron oxide were separated. The pre-crushed material was then added to the air that was blown in through the inlet 12 to a cyclone of the type that has been described. The material was crushed to a particle size of approximately maximum 3 mm in the cyclone, and it exited through the outlet 14. This material was separated by a commercially available strong magnetic separation plant into six different fractions by the use of different field strengths. The fraction that was removed first at the lowest field strength contained a total iron content of 30% in the form of iron and iron oxide, while the last fraction contained a weight percentage of iron oxide of 0.2%. Thus it is possible to separate mineral particles that have different mineral compositions. New magnesite bricks also contain 0.2 weight percentage of iron oxide as a contaminant and for this reason the last fraction can be reused for the manufacture of magnesite bricks. It proved to be the case that the paramagnetic susceptibility of the MgO alone had risen from close to zero to 600×10⁻⁶ cmg/s by the treatment in the cyclone, while the paramagnetic susceptibility for the iron oxide had risen from approximately 1,000×10⁻⁶ to approximately 10,000×10⁻⁶ cmg/s. The difference in paramagnetic susceptibility between the original MgO and the original iron oxide is too small to be able to separate the minerals, while the difference after the treatment is more than sufficient for strong magnetic separation.

This experiment shows that high-value ceramic material can be recycled despite very severe infiltration of another mineral than the ceramic mineral or minerals, and that the separated ceramic material can be reused to produce high-value ceramic material. The properties of the cyclone can be varied in order to adapt it to the input material and the desired output material through a testing carried out by one skilled in the arts of the axial positions of the vortex collector 15 and the size of the exit restriction 21.

### Example 2

Naturally occurring ilmenite sand was processed in the cyclone two times and subsequently subjected to magnetic separation. In this manner, sand particles that did not contain chrome oxide were separated from sand particles that did contain chrome oxide in that the different sand particles were magnetised to different degrees. This separation could not be carried out by strong magnetic processing of the sand in its natural state. The moist sand was also dried in the cyclone. A certain degree of crushing of the sand is also achieved and this crushing can be regulated in the same way as in Example 1. It is possible that the sand needs to be processed only once during production, following adjustment of the cyclone by one skilled in the arts. The examples given above are only examples of the invention. The invention can be applied in innumerable other fields. It is generally the case for the invention that a mixture of materials A, B, C, D is added to a cyclone device 10 according to the previous description, whereby the cyclone device breaks the mixture of materials down into smaller fractions and dries the mixture of materials, and it modifies (increases) the magnetic properties of the materials. The milled mixture of materials A-D that leaves the cyclone device is further processed, with or without intermediate steps such as transport or sieving, etc., by means of magnetic separation in which a number of magnets M1,M2,M3,M4 of different strengths are used. It is appropriate to use electromagnets, the field strengths of which can be adjusted.

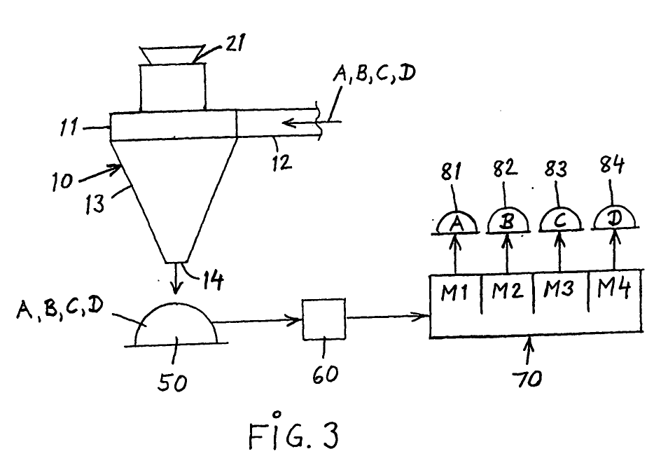

That which has just been described is shown schematically in FIG. 3 where a mixture of materials A-D is added to a cyclone device 10. When the mixture of materials A-D leaves the cyclone device 10 it has been further crushed and dried, while at the same time the magnetic properties of the materials A-D have been modified in that the magnetism has been increased to different degrees. The mixture of materials A-D that has been treated by the cyclone device 10 has been given the reference number 50 in FIG. 3. A possible intermediate step comprising, for example, of transport and/or sieving, has been given the reference number 60. An arrangement 70 for magnetic separation, which comprises the magnets M1-M4 with successively increasing field strengths calculated along the direction of feed, is subsequently used to separate the materials A-D into four different heaps 81-84 as is illustrated in FIG. 3. The detailed design and construction of the arrangements can, naturally, be varied within the framework of the innovative concept of the invention.

It is possible with the method according to the invention to carry out magnetic separation of mixtures of materials that would previously have been impossible to separate due to the similar magnetic properties of the materials. The crushing effect of the cyclone device and its ability to modify magnetisations can, among other things, be regulated with the aid of the degree of closure of the outlet 21. The cyclone device is adjusted such that the degree of fineness of the crushing and the degree of charging or the modification of the magnetic properties of the materials are adjusted according to the demands of the subsequent magnetic separation.

Thus, the invention is not restricted to the illustrated and described embodiments, since changes and modifications are possible within the scope of the accompanying claims.

1. A method to separate different materials from each other, such as, for example, elements and/or compounds of elements, characterised in that the material is pre-treated in a cyclone device (10) that comprises a restricted outlet (21) for a gaseous medium and an outlet (14) for material treated in the cyclone, whereby the cyclone device breaks the material down into smaller fractions and changes the magnetic properties of the materials, and in that the different materials are subsequently separated from each other by means of magnetic separation.

2. The method according to claim 1, characterised in that a material that contains different materials is pre-treated in the cyclone and particles with different mineral compositions are subsequently separated by magnet separation.

3. The method according to claim 2 in order to separate uncontaminated ceramic material from contaminated ceramic material.

4. The method according to claim 3 applied to residual ceramic materials from metallurgical industry in order to obtain ceramic particles for reuse.

5. The method according to claim 2 applied to bricks from metallurgical ovens, characterised in that the bricks are crushed to a maximum particle size of 1-5 cm before the material is added to the cyclone.

6. The method according to claim 2 applied to ilmenite sand in order to separate ilmenite sand particles free of chrome oxide from sand particles with chrome oxide.

7. The use of a method according to claim 1 in order to separate different materials in mixture of materials from each other.

8. The method according to claim 3, applied to bricks from metallurgical ovens, characterised in that the bricks are crushed to a maximum particle size of 1-5 cm before the material is added to the cyclone.

9. The use of a method according to claim 2 in order to separate different materials in mixture of materials from each other.

10. The use of a method according to claim 3 in order to separate different materials in mixture of materials from each other.

11. The use of a method according to claim 4 in order to separate different materials in mixture of materials from each other.

12. The use of a method according to claim 5 in order to separate different materials in mixture of materials from each other.

13. The use of a method according to claim 6 in order to separate different materials in mixture of materials from each other.

14. The use of a method according to claim 8 in order to separate different materials in mixture of materials from each other.
